(19) United States
(12) Patent Application Publication
(10) Pub. No.: US 2026/0246638 A1
(43) Pub. Date: Aug. 20, 2026

(54) REAL TIME INTERACTION USING DIGITAL TOKEN

(71) Applicant: VISA INTERNATIONAL SERVICE ASSOCIATION, San Francisco, CA (US)

(72) Inventors: Nimish Jain, Bengaluru, Karnataka (IN); Sudheer Kumar Bhavana, East Godavari, Andhra Pradesh (IN); Prashant Jhingran, Bengaluru, Karnataka (IN)

(73) Assignee: VISA INTERNATIONAL SERVICE ASSOCIATION, San Francisco, CA (US)

(21) Appl. No.: 19/162,376

(22) PCT Filed: Mar. 27, 2023
(86) PCT No.: PCT/US2023/016460

§ 371 Date: Sep. 4, 2025

(51) Int. Cl. H04L 9/32; H04L 9/00; H04L 9/08

(52) U.S. Cl. CPC H04L 9/3213; H04L 9/0825; H04L 9/3247; H04L 9/50

(57) ABSTRACT

A method for providing interactive recording networks is disclosed. Multiple separate local networks can be connected through a central network. Digital tokens can be used to perform transfers from a first local network across the central network to a second local network. Digital tokens can be redeemed, and digital tokens can be verified using counter values.

### CROSS REFERENCE TO RELATED APPLICATIONS

None.

### BACKGROUND

Many networks and applications exist for recording information. For example, there are multiple systems and networks designed for recording patient medical information, such as various hospital-specific networks and insurance provider-specific networks. Similarly, there are multiple distinct networks for managing voter registration data (e.g., at various local, state, and national levels). Additional networks exist for recording information about transferring assets and data. For example, multiple distinct networks exist for transferring access credentials, event tickets, property rights, currency, game credits, tokens, mobile phone minutes, digital media, etc. In the case of event tickets, if someone wants to transfer an event ticket to a friend, they can choose one of several ticket transfer networks and applications.

It can be beneficial to unify and simplify many types of information recording networks. For example, if all networks for transferring mobile phone minutes, currency, etc. were combined into a single, global network, it could simplify the transfer process. Participants could have just one application which is configured for the one network. Additionally, it could simplify record keeping, as one network could keep track of where all mobile phone minutes have been moved.

However, unifying recording networks can present new problems. For example, coordinating all new records and/or transfers can be a large task, and may be too large a burden for a single network coordinator.

Embodiments of the invention address these and other problems individually and collectively.

### SUMMARY

Embodiments of the invention provide systems and methods for making distinct networks interactive. In some embodiments, instead of providing a single global network, multiple independent local networks can be established. The local networks can each be configured to interact with a central network. For example, a central authority for a local network can also act as a participating node in the central network, and can thereby relay some information between the local network and central network in real time. If each local network interacts with the central network, the different local networks can be indirectly connected to one another through the central network. This allows a value transfer to take place in real time between participants in different local networks.

Additionally, embodiments provide for digital tokens that can serve as an intermediary value between local values. A first local network may transfer value using a first exchange medium (e.g., a first type of currency), a second local network may transfer value using a second exchange medium (e.g., a second type of currency), and the central network may transfer value using digital tokens that can represent and/or be exchanged for both the first exchange medium and the second exchange medium. A digital token can also be monitored and verifiable based on a counter value and recorded previous usage of the digital token. Further, a digital token can be destroyed after being redeemed for the token value for a local exchange medium.

One embodiment of the invention is directed to a method. The method comprises transferring, by first node computer operated by a first entity, a first value of an exchange medium to a first central authority computer. The first central authority computer then sends a message to a network processing computer informing the network processing computer about the transfer of the first value. The method further includes receiving from the network processing computer a digital token comprising a digital token identifier, an owner identifier identifying the first entity, a counter value, a token value, a first digital signature. The method also comprises updating the digital token to transfer the digital token to a second node computer operated by a second entity by increasing the counter value, changing the owner to the second entity, and adding a second digital signature of the first node computer. The method also includes broadcasting the updated digital token to nodes in a blockchain network. The blockchain network comprises the first node computer, the second node computer, the first central authority computer, and the network processing computer. The nodes record the updated digital token to their respective blockchains.

Another embodiment of the invention is directed to a first node computer configured to perform the above-described method.

Another embodiment of the invention is directed to a method. The method comprises receiving, by a network processing computer, a message regarding a transfer by a first node computer operated by a first entity of a first value of an exchange medium to a first central authority computer. The method further comprises transferring, to the first node computer, a digital token comprising a digital token identifier, an owner identifier identifying the first entity, a counter value, a token value, a first digital signature. The first node computer updates the digital token to transfer the digital token to a second node computer operated by a second entity by increasing the counter value, changing the owner to the second entity, and adding a second digital signature of the first node computer. The method also includes receiving a broadcast message comprising the updated digital token, and updating a blockchain stored in the network processing computer with the updated digital token. The network processing computer is in blockchain network comprising the first node computer, the second node computer, the first central authority computer, and the network processing computer.

Another embodiment of the invention is directed to a network processing computer configured to perform the above-described method.

Further details regarding embodiments of the invention can be found in the Detailed Description and the Figures.

### BRIEF DESCRIPTION OF THE DRAWINGS

FIG. 1 shows a block diagram of a system according to an embodiment of the invention.

FIG. 2 shows a block diagram of a network processing computer, according to an embodiment of the invention.

FIG. 3 shows a block diagram of a first node computer, according to an embodiment of the invention.

FIG. 4 shows an example of nodes in a network, according to an embodiment of the invention.

FIG. 5 shows a diagram illustrating a portion of a blockchain, according to an embodiment of the invention.

FIG. 6 shows a block diagram illustrating data fields of a digital token according to some embodiments.

FIG. 7 shows a flow diagram illustrating a method for issuing a digital token, according to embodiments of the invention.

FIG. 8 shows a flow diagram illustrating a method for transferring a digital token, according to embodiments of the invention.

FIG. 9 shows a flow diagram illustrating a method for exchanging or redeeming a digital token, according to embodiments of the invention.

FIG. 10 shows a flow diagram illustrating a method for processing a failed digital token verification, according to embodiments of the invention.

### DETAILED DESCRIPTION

Embodiments of the invention provide systems and methods for layered and interactive recording networks. In some embodiments, multiple local networks can be established as well as a central network. The central network and each of the local networks can function independently, and can maintain their own distinct sets of records. The local networks can interact with one another through the central network.

For example, a central authority for a local network can also act as a participant (e.g., a node) in the central network. As a result, each local network coordinator can communicate with the central network. Through the central network, the local networks can be indirectly connected. As a result, separate local networks can maintain privacy and customizable local rules and procedures, and at the same time a global-level of connectivity is established.

Additionally, embodiments provide digital tokens that can serve as an intermediary value between local values. A first local network may transfer value using a first exchange medium, a second local network may transfer value using a second exchange medium, and the central network may transfer value using digital tokens that can represent and/or be exchanged for both the first exchange medium and the second exchange medium.

According to embodiments, within the central network, digital tokens can be monitored and verifiable based on a counter value and/or recorded previous usage of the digital token, thereby providing a secure mechanism for cross-network value transfers. Digital tokens may be transferred multiple times to multiple different owners, and the counter value can be increased at each transfer and/or change of ownership.

Further, a digital token can be redeemed the token value for a local exchange medium. At that time, the digital token can be destroyed and removed from circulation. As a result, the central network provides a secure, temporary, redeemable, and disposable medium for cross-network exchange.

Prior to discussing specific embodiments of the invention, some terms may be described in detail.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment. An interaction can be a transfer of a resource from a first entity to a second entity.

A “value” may include an amount, an asset, or a set of information with worth. For example, a value can include an amount of currency, access rights, or login credentials. A value can change ownership by being transferred from a first owner to a second owner. Examples of value transfers include payment transactions where currency (e.g., physical currency or digital currency) is transferred, credit transfers such as where game credits or mobile phone minutes are transferred, and property transfers where event tickets or property deeds are transferred.

An “exchange medium” may include an intermediary instrument used to facilitate an interaction. For example, an exchange medium can include physical currency, digital currency, cryptocurrency, tokens, credits, or points. Different types of exchange mediums may be utilized in different contexts, regions, or environments. For example, different fiat currencies may be utilized in different countries.

A “digital token” may be a digital substitute value or a digital representative value. A digital token may be a string of numbers, letters, other suitable characters, or information that exists in binary format. In some embodiments, a digital token can include information about value that is transferrable in an interaction.

The term “node” may refer to a connection point. In some embodiments, a node may be a physical electronic device that is capable of creating, receiving, or transmitting data. In other embodiments, a node may be a software module on a computing device, the software module a connection point in a communication network. In some embodiments, a node may be a computing device within a record-keeping network. A node may be able to create a record, validate a record, and/or perform any other suitable functions. Different types of nodes may be able to perform different sets of functions within a recording network. In some embodiments, a node may be associated with and/or operated by a financial institution computer (e.g., a bank), a payment processor computer, a third party computer, or any other suitable entity.

A “record” may refer to evidence of one or more interactions, changes, or events. A digital record can be electronic documentation of an interaction, change, or event. A record can include a record identifier and record information. For example, record information can include information describing one or more interactions and/or information associated with the interactions (e.g., a digital signature). An example of a record is a block in a blockchain. An individual block can be an individual record, and a blockchain can be a series of records. A blockchain header is an example of a record identifier, and a blockchain body is an example of record information.

A “blockchain” can be a distributed database that maintains a continuously growing list of records secured from tampering and revision. A blockchain can be a digital token blockchain, a central bank digital currency blockchain, or a combination thereof. A blockchain may include a number of blocks of interaction records. Each block in the blockchain can also include a timestamp and a link to a previous block. Stated differently, interaction records in a blockchain may be stored as a series of “blocks,” or permanent files that include a record of a number of interactions occurring over a given period of time. Blocks may be appended to a blockchain by an appropriate node after it creates the block and the block is validated. Each block can be associated with a block header. In embodiments of the invention, a blockchain may be distributed, and a copy of the blockchain may be maintained at each full node in a verification network. Any node within the verification network may subsequently use the blockchain to verify interactions. A blockchain can be stored, maintained, and updated in a distributed manner in a peer-to-peer network. For example, in a cryptocurrency application, such as Bitcoin or Ethereum, Ripple, Dash, Litecoin, Dogecoin, zCash, Tether, Bitcoin Cash, Cardano, Stellar, EOS, NEO, NEM, Bitshares, Decred, Augur, Komodo, PIVX, Waves, Steem, Monero, Golem, Stratis, Bytecoin, Ardor, or in digital currency exchanges, such as Coinbase, Kraken, CEX.IO, Shapeshift, Poloniex, Bitstamp, Coinmama, Bisq, LocalBitcoins, Gemini and others where the distributed ledger represents each transaction and where units of the cryptocurrency are transferred between entities.

A “blockchain network” can include a computer network that maintains a blockchain.

A “block header” can be a header including information regarding a block in a blockchain. A block header can be used to identify a particular block on a blockchain. A block header can comprise any suitable information, such as a previous hash, a Merkle root, a timestamp, and a nonce. In some embodiments, a block header can also include a difficulty value.

A “key pair” may include a pair of linked encryption keys. For example, a key pair can include a public key and a corresponding private key. In a key pair, a first key (e.g., a public key) may be used to encrypt a message, while a second key (e.g., a private key) may be used to decrypt the encrypted message. Additionally, a public key may be able to verify a digital signature created with the corresponding private key. The public key may be distributed throughout a network in order to allow for verification of messages signed using the corresponding private key. Public and private keys may be in any suitable format, including those based on RSA or elliptic curve cryptography (ECC). In some embodiments, a key pair may be generated using an asymmetric key pair algorithm. However, a key pair may also be generated using other means, as one of ordinary skill in the art would understand.

The term “digital signature” may refer to an electronic signature for a message. A digital signature may be a numeric data value, an alphanumeric data value, or any other type of data including a graphical representation. A digital signature may be a unique data value generated from a message and a private key using an encrypting algorithm. In some embodiments, a validation algorithm using a public key may be used to verify the signature.

A “network processing computer” may include a server computer used for interaction processing. In some embodiments, the network processing computer may be coupled to a database and may include any hardware, software, other logic, or combination of the preceding for servicing the requests from one or more client computers. The network processing computer may comprise one or more computational apparatuses and may use any of a variety of computing structures, arrangements, and compilations for servicing the requests from one or more client computers. In some embodiments, a network processing computer may include data processing subsystems, networks, and operations used to support and deliver authorization services, exception file services, and clearing and settlement services. An exemplary network processing computer may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The network processing computer may use any suitable wired or wireless network, including the Internet.

The network processing computer may process interaction-related messages (e.g., authorization request messages and authorization response messages) and determine the appropriate destination computer (e.g., an issuer computer) for the interaction-related messages. In some embodiments, the network processing computer may authorize interactions on behalf of an issuer. The network processing computer may also handle and/or facilitate the clearing and settlement of interactions.

The term “verification” and its derivatives may include a process that utilizes information to determine whether an underlying subject is valid under a given set of circumstances. Verification may include any comparison of information to ensure some data or information is correct, valid, accurate, legitimate, and/or in good standing.

A “user” may include an individual. In some embodiments, a user may be associated with one or more personal accounts and/or mobile devices. The user may also be referred to as a cardholder, account holder, or consumer in some embodiments.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers.

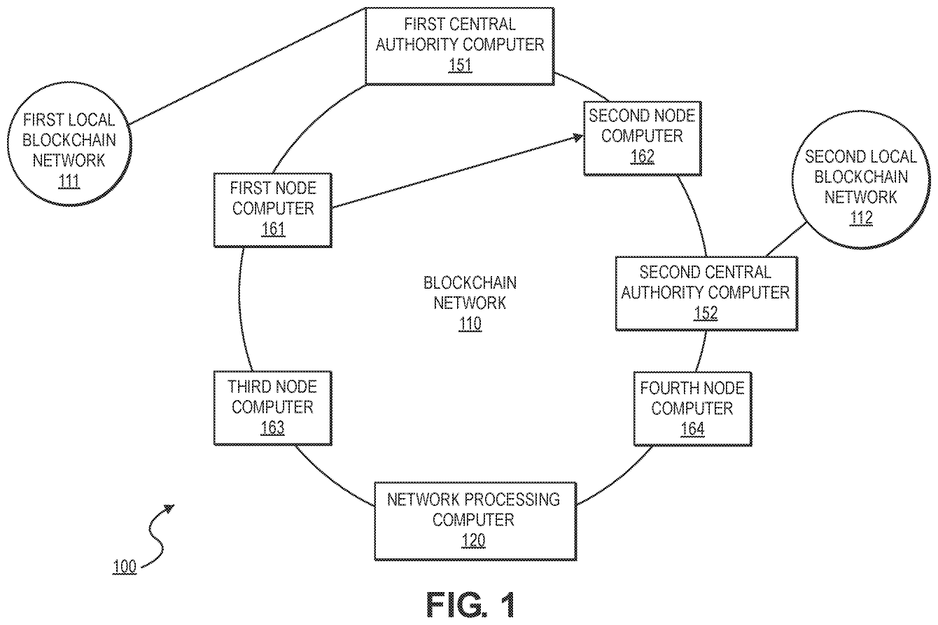

FIG. 1 shows a system 100 comprising a number of components. The system 100 comprises a blockchain network 110 that includes a plurality of network nodes. The network nodes can include a first node computer 161, a second node computer 162, a third node computer 163, a fourth node computer 164, a first central authority computer 151, a second central authority computer 152, and/or a network processing computer 120. In some embodiments, the blockchain network 110 can be a central network that serves as an intermediary between two or more additional local blockchain networks. For example, certain nodes (e.g., the first central authority computer 151 and/or the second central authority computer 152) in the central blockchain network 110 may also be associated with and/or operate separate local blockchain networks (e.g., the first local blockchain network 111 and the second local blockchain network 112). Such nodes may utilize the central blockchain network 110 to transfer information from a first local blockchain network 111 to a second local blockchain network 112.

All of the computers shown in the system 100 may be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The system 100 may be used to process, approve, and record any suitable type of information. For example, the system 100 can be used to record information about new or updated digital tokens, transactions, projects and activities, medical patient data, academic achievements, etc. The system 100 can be configured to create and maintain records of any suitable types. For example, one or more digital tokens and/or transactions can be recorded in a block for a blockchain.

Some or all of the network nodes may be able to create new block records and/or validate new block records received from another network node. Together, the network nodes can build and maintain a common blockchain record. According to embodiments, some or all network nodes may maintain a local blockchain copy.

Each network node may be associated with and/or operated by a corresponding entity. For example, the first node computer 161 may be operated by a first entity. The first entity may be a financial institution, a hospital, a government agency, an academic institution, a mobile phone service provider, or any other suitable service provider. The first entity can operate the first node computer 161 to maintain one or more accounts on behalf of one or more users. Accounts may store identity information, medical records, academic records, financial information, or any other suitable details depending on the type of service provider. The first entity may be associated with and/or located within a first country, first region, first currency, and/or first central authority.

In embodiments where the first node computer 161 is operated by a first financial institution, the first node computer 161 may store value on behalf of a user. The first node computer 161 may also be able to transfer value (e.g., provide a payment) on behalf of the user. An example of a financial institution is an issuer, which may typically refer to a business entity (e.g., a bank) that issues and maintains an account (e.g., a bank account) for a user.

In some embodiments, the first node computer 161 can be representative of multiple associated computers. For example, the functionality described above for network participation and the functionality associated with banking services can be divided among several cooperative computers.

Similar to the first node computer 161, the second node computer 162 can be associated with a second entity. The second entity may be a service provider such as a bank. As a result, the second node computer 162 can host a second user account, and can store, send, and/or receive a value on behalf of a second user. As an example the second node computer 162 can be associated with an acquirer, which may typically be a business entity (e.g., a commercial bank) that has a business relationship with a particular resource provider or other entity. Some entities can perform both issuer and acquirer functions. Some embodiments may encompass such single entity issuer-acquirers. The second entity may be associated with and/or located within a second country, second region, second currency, and/or second central authority.

A user can be an individual, a business, an organization's record-updating administrator, or any other suitable type of user. For example the first user can be an individual, and the second user can be a resource provider (e.g., a merchant) that engages in transactions and can sell goods or services, or provide access to goods or services.

The first central authority node computer 151 may be operated by a first central authority. For example, a first central authority may be a first central bank. A central bank may be associated with a certain country, region, and/or currency type. A central bank may manage, issue, and/or otherwise control one or more types of exchange mediums, such as a physical currency and/or a digital currency. For example, the first central bank (e.g., via the first central authority node computer 151 or a separate computer) may issue, manage, and/or otherwise control a first fiat currency (e.g., physical US Dollars). The first central bank (e.g., via the first central authority node computer 151 or a separate computer) may also issue, manage, and/or otherwise control a first type of central bank digital currency (CBDC), such as digital US dollars. The first type of CBDC may be referred to as CBDC-A.

CBDC (central bank digital currency) can be a digital liability of a central bank of a government. CBDC can be a digital form of central bank money. “Central bank money” can refer to money that is a liability of a central bank. In the U.S., there are currently two types of central bank money: physical currency issued by the Federal Reserve and digital balances held by commercial banks at the Federal Reserve. With CBDC, a central bank computer can issue and record ownership of CBDC as well as CBDC transactions on a local blockchain network 111.

In some embodiments, the first central authority may (e.g., via the first central authority node computer 151) operate and/or manage a first local blockchain network 111, in addition to participating in the blockchain network 110 (which may be referred to as a central blockchain network, an intermediary blockchain network, or a primary blockchain network). For example, the first local blockchain network 111 may be used to store records regarding generating, transfer, and ownership of CBDC-A.

The second central authority node computer 152 may be operated by a second central authority. For example, a second central authority may be a second central bank. The second central bank may (e.g., via the second central authority node computer 152 or a separate computer) issue, manage, and/or otherwise control a second fiat currency (e.g., physical European Euros). The second central bank (e.g., via the second central authority node computer 152 or a separate computer) may also issue, manage, and/or otherwise control a second type of CBDC (e.g., digital European Euros), which may be referred to as CBDC-B.

In some embodiments, the second central authority may (e.g., via the second central authority node computer 152) operate and/or manage a second local blockchain network 112, in addition to participating in the central blockchain network 110. For example, the second local blockchain network 112 may be used to store records regarding generating, transfer, and ownership of CBDC-B.

As mentioned above, in some embodiments, the blockchain network 110 can serve as an intermediary between two or more additional local blockchain networks. For example, the first central authority computer 151 and/or the second central authority computer 152 may utilize the central blockchain network 110 to transfer information between the first local blockchain network 111 and the second local blockchain network 112.

The network processing computer 120 may by operated by a central network processor or administrator. The network processing computer 120 may act as a node that creates and/or validates new blocks for the blockchain. Additionally, the network processing computer 120 may track a transaction from start to finish and provide communication updates to entities and nodes participating in the transaction. For example, the blockchain may primarily be used for recording new digital tokens, changes to digital tokens, and transfers of digital tokens. However, a complete transaction may involve steps and communications beyond digital tokens, such as issuing and transferring CBDC. Accordingly, separate from the blockchain, the network processing computer 120 may maintain additional records and/or accounts regarding transactions, according to some embodiments. For example, the network processing computer 120 may provide an interaction identifier for a transaction, monitor and track each step involved in the transaction, inform one or more entities when relevant transfer steps are completed, maintain and update an escrow account for the transaction, and/or otherwise coordinate transaction activities.

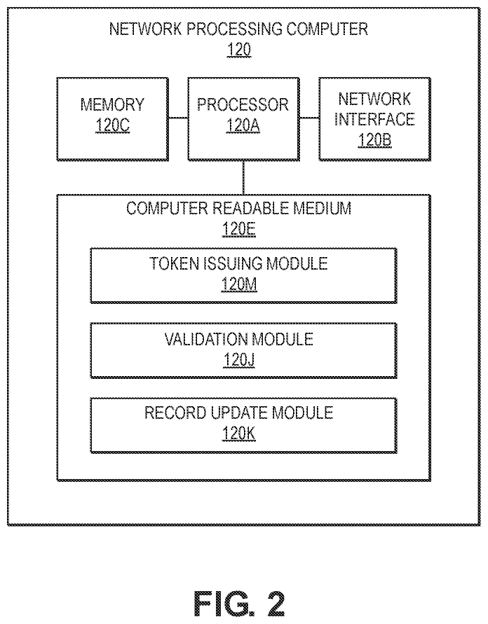

FIG. 2 shows a block diagram of a network processing computer 120 according to embodiments. The exemplary network processing computer 120 may comprise a processor 120A. The processor 120A may be coupled to a memory 120C, a network interface 120B, and a computer readable medium 120E. The computer readable medium 120E can comprise a token issuing module 120M, a validation module 120J, and a record update module 120K.

The memory 120C can be used to store data and code. For example, the memory 120C can store one or more public keys associated with one or more nodes, a private key associated with the network processing computer 120A, one or more digital tokens, one or more blockchain records, one or more escrow account records, etc. The memory 120C may be coupled to the processor 120A internally or externally (e.g., cloud based data storage), and may comprise any combination of volatile and/or non-volatile memory, such as RAM, DRAM, ROM, flash, or any other suitable memory device.

The computer readable medium 120E may comprise the token issuing module 120M, the validation module 120J, the record update module 120K, and any other suitable software module. The computer readable medium 120E may also comprise code, executable by the processor 120A for implementing a method comprising: receiving a message regarding a transfer by a first node computer operated by a first entity of a first value of an exchange medium to a first central authority computer; transferring, to the first node computer, a digital token comprising a digital token identifier, an owner identifier identifying the first entity, a counter value, a token value, a first digital signature, wherein the first node computer updates the digital token to transfer the digital token to a second node computer operated by a second entity by increasing the counter value, changing the owner to the second entity, and adding a second digital signature of the first node computer; receiving a broadcast message comprising the updated digital token; updating a blockchain stored in the network processing computer with the updated digital token, wherein the network processing computer is in blockchain network comprising the first node computer, the second node computer, the first central authority computer, and the network processing computer.

The token issuing module 120M may comprise code that causes the processor 120A to issue digital tokens. For example, the token issuing module 120M may contain logic that causes the processor 120A to generate a digital token with one or more data fields that may comprise a token identifier, an owner identifier, a counter value, an interaction identifier, a currency amount, a currency denomination, and/or a digital signature.

The validation module 120J may comprise code that causes the processor 120A to validate a digital token and/or blockchain block. For example, the validation module 120J may contain logic that causes the processor 120A to check whether a record of a received digital token exists in the blockchain, and/or that the received digital token includes an expected counter value. Additionally, the validation module 120J may contain logic that causes the processor 120A to validate a new block received from another network node.

The validation module 120J may further comprise code that causes the processor 120A to verify the authenticity of one or more digital signatures. For example, the validation module 120J may contain logic that causes the processor 120A to use a node computer's public key to verify the authenticity of a digital signature associated with that node computer.

The record update module 120K may comprise code that causes the processor 120A to maintain and update a set of records. For example, the record update module 120K may contain logic that causes the processor 120A to record information about a new digital token or an updated digital token. In some embodiments, the record update module 120K may include instructions for generating a new blockchain block including a new digital token or an updated digital token.

The network interface 120B may include an interface that can allow the network processing computer 120 to communicate with external computers. The network interface 120B may enable the network processing computer 120 to communicate data to and from another device (e.g., the first node computer 161, the second node computer 162, etc.). Some examples of the network interface 120B may include a modem, a physical network interface (such as an Ethernet card or other Network Interface Card (NIC)), a virtual network interface, a communications port, a Personal Computer Memory Card International Association (PCMCIA) 120B and card, or the like. The wireless protocols enabled by the network interface 120B may include Wi-Fi™. Data transferred via the network interface 120B may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 120B and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

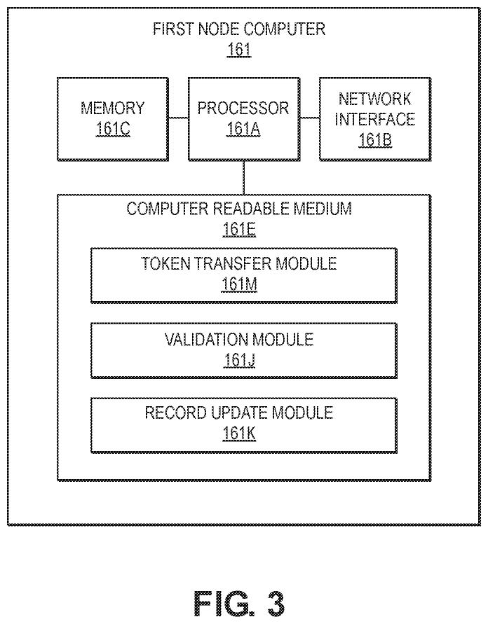

FIG. 3 shows a block diagram of a first node computer 161 according to embodiments. In some embodiments, the first node computer 161 can comprise an HSM (hardware security module). The exemplary first node computer 161 may comprise a processor 161A. The processor 161A may be coupled to a memory 161C, a network interface 161B, and a computer readable medium 161E. The computer readable medium 161E can comprise a token transfer module 161M, a validation module 161J, and a record update module 161K. Some or all of the components, modules, and/or functionalities described with respect to the first node computer 161 can also apply to other network nodes, such as the second node computer 162, third node computer 163, fourth node computer 164, first central authority computer 151, and/or second central authority computer 152.

The memory 161C can be used to store data and code. For example, the memory 161C can store one or more public keys associated with one or more nodes, a private key associated with the first node computer 161A, one or more digital tokens, one or more blockchain records, etc. The memory 161C may be coupled to the processor 161A internally or externally (e.g., cloud based data storage), and may comprise any combination of volatile and/or non-volatile memory, such as RAM, DRAM, ROM, flash, or any other suitable memory device.

The computer readable medium 161E may comprise the token transfer module 161M, the validation module 161J, the record update module 161K, and any other suitable software module. The computer readable medium 161E may also comprise code, executable by the processor 161A for implementing a method comprising: transferring a first value of an exchange medium to a first central authority computer, which sends a message to a network processing computer informing the network processing computer about the transfer of the first value; receiving, from the network processing computer, a digital token comprising a digital token identifier, an owner identifier identifying a first entity, a counter value, a token value, a first digital signature; updating the digital token to transfer the digital token to a second node computer operated by a second entity by increasing the counter value, changing the owner to the second entity, and adding a second digital signature of the first node computer; and broadcasting the updated digital token to nodes in a blockchain network, the blockchain network comprising the first node computer, the second node computer, the first central authority computer, and the network processing computer, wherein the nodes record the updated digital token to their respective blockchains.

The token transfer module 161M may comprise code that causes the processor 161A to transfer digital tokens. For example, the token transfer module 161M may contain logic that causes the processor 161A to obtain a digital token, update the digital token (e.g., a counter value and an owner identifier) for a transaction, and broadcast the updated digital token and/or a blockchain update that includes the updated digital token.

The validation module 161J may comprise code that causes the processor 161A to validate a digital token and/or blockchain block. For example, the validation module 161J may contain logic that causes the processor 161A to check whether a record of a received digital token exists in the blockchain, and/or that the received digital token includes an expected counter value. Additionally, the validation module 161J may contain logic that causes the processor 161A to validate a new block received from another network node.

The validation module 161J may further comprise code that causes the processor 161A to verify the authenticity of one or more digital signatures. For example, the validation module 161J may contain logic that causes the processor 161A to use a node computer's public key to verify the authenticity of a digital signature associated with that node computer.

The record update module 161K may comprise code that causes the processor 161A to maintain and update a set of records. For example, the record update module 161K may contain logic that causes the processor 161A to record information about a new digital token or an updated digital token. In some embodiments, the record update module 161K may include instructions for generating a new block for a blockchain.

The network interface 161B may include an interface that can allow the first node computer 161 to communicate with external computers. The network interface 161B may enable the first node computer 161 to communicate data to and from another device (e.g., the processing network computer 161, the second node computer 162, etc.). Some examples of the network interface 161B may include a modem, a physical network interface (such as an Ethernet card or other Network Interface Card (NIC)), a virtual network interface, a communications port, a Personal Computer Memory Card International Association (PCMCIA) 161B and card, or the like. The wireless protocols enabled by the network interface 161B may include Wi-Fi™. Data transferred via the network interface 161B may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 161B and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

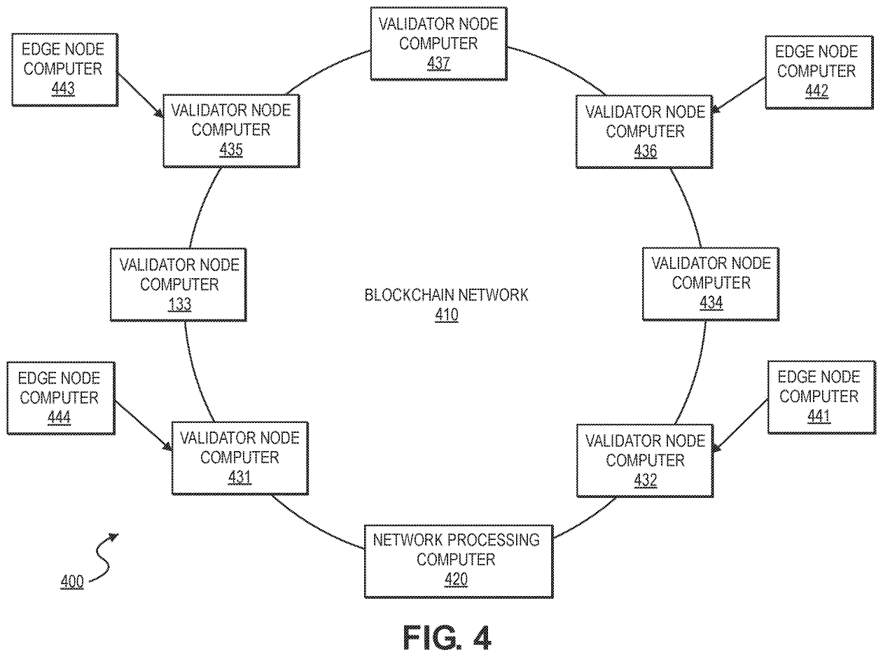

In some embodiments, the system 100 can include different types of network nodes. FIG. 4 shows an example of nodes in a network, according to an embodiment of the invention. As shown, the blockchain network 410 can include a plurality of network nodes including validator node computers 431-437, edge node computers 441-444, and a network processing computer 420.

The validator nodes and edge nodes can have different roles and perform different sets of functions in the blockchain network 410. For example, the validator node computers 431-437 can validate new records (e.g., blocks, digital tokens, and or transactions) for the network. Maintaining the integrity of the network in this manner may utilize compute resources, and thus may typically be performed by larger entities (e.g., central banks, larger banks) with a greater available infrastructure. For example, the first central authority computer 151 and/or the second central authority computer 152 in FIG. 1 may serve as validator nodes in the blockchain network 110.

The edge node computers 441-444 can create and/or submit new records (e.g., blocks, digital tokens, and or transactions) to the network. However, in some embodiments, edge nodes may not validate new records, and thus may be dependent on validator nodes for storing and maintaining blockchain. Edge nodes may typically be operated by smaller entities, such as small banks or regional banks. For example, the first node computer 161, second node computer 162, third node computer 163, and/or fourth node computer 164 in FIG. 1 may serve as edge nodes in the blockchain network 110.

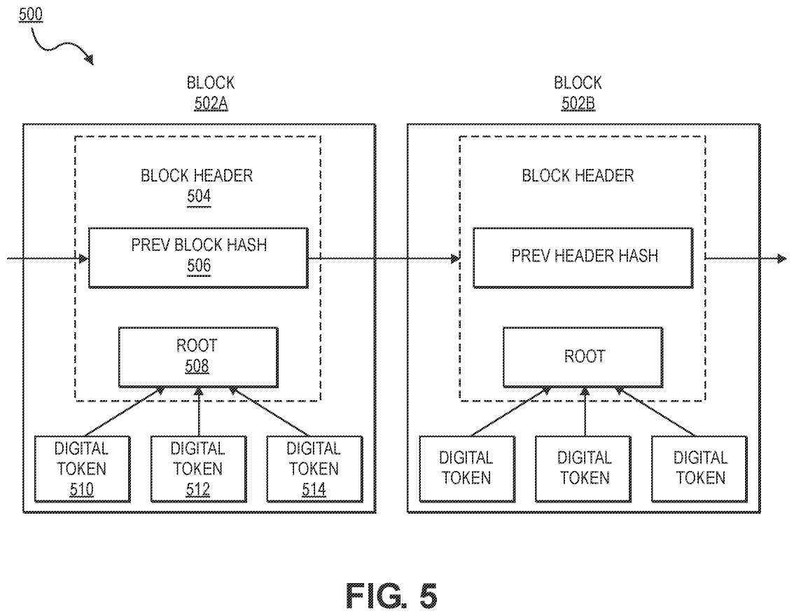

FIG. 5 shows a block diagram illustrating a blockchain according to embodiments. A blockchain 500 can include a list of blocks of tokens, the blocks are cryptographically chained together as depicted in FIG. 5. A block is created by a computationally intensive process called proof-of-work in which valid blocks need to demonstrate a sufficient “difficulty” (e.g., sufficient computation power to create on average). In some embodiments, the blockchain can utilize a proof-of-stake process rather than a proof-of-work process. If there are more than one available chains of blocks, then network participants (e.g., nodes) need to download all blocks in all chains and follow the chain which has the highest total difficulty. This mechanism guarantees that, eventually, the network will agree on a single and valid chain.

FIG. 5 shows an example blockchain format. However, it is understood that other formats and data structures can be utilized. The blockchain 500 can comprise a plurality of blocks, for example, block 502A and block 502B. Each block can comprise a block header, for example, block 502A comprises block header 504.

The block header 504 can include multiple data elements, such as a previous block hash 506 and a Merkle root 508. The previous block hash 506 can be a hash of the previous block's header. The Merkle root 508 can be a root of a Merkle tree, which is a tree in which every leaf node is labelled with the hash of a data block, for example, data the digital tokens 510, 512, and 514. Each leaf of the Merkle tree can represent one of the digital tokens 510, 512, and 514.

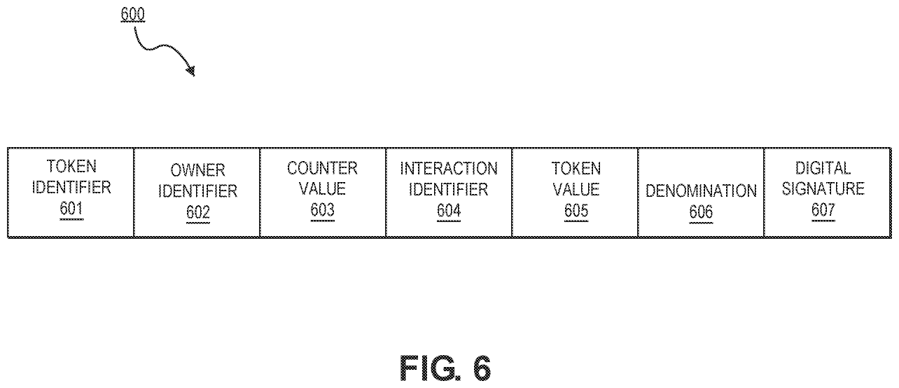

FIG. 6 shows a block diagram of a digital token, according to some embodiments. FIG. 6 illustrates an example digital token 600 and data included therein. The digital token 600 includes a token identifier 601, an owner identifier 602, a counter value 603, an interaction identifier 604, a token value 605, a currency denomination (currency and value) 606, and a digital signature 607.

The digital token 600 can be identified by the token identifier 601. The token identifier 601 can be an alphanumeric value that is unique to one digital token. In some embodiments, the token identifier 601 is a GUID (globally unique identifier). In some embodiments, the token identifier 601 is a static value for the life of the digital token.

Ownership of the digital token 600 can managed through the token identifier 601 and the owner identifier 602. In some embodiments, the owner identifier may be a specific alphanumeric value that is unique to an owner. In some embodiments, the owner identifier 602 is a GUID (globally unique identifier). In some embodiments, the owner identifier may be a public address (e.g., a public key) associated with the owning entity. When the digital token 600 is transferred to a new entity, the owner identifier 602 can be updated to indicate that entity. A private key corresponding to the public key can serve as proof-of-ownership of the digital token 600. A digital signature created by the private key corresponding to the public key, to which the digital token 600 is assigned, can act as proof that the entity supplying the signature owns the digital token 600.

The counter value can serve to track the number of times that the digital token 600 has been transferred, owned, or otherwise utilized. The counter value can be initially set to 1 or a random value. At each transfer of the digital token 600, the counter value can be increased by one. For example, at the first transfer of the digital token 600, the counter value can be increased from the value 1 to the value 2, and at the second transfer of the digital token 600, the counter value can be increased from the value 2 to the value 3. Each change of the counter value can be recorded in the blockchain. As a result, the counter value in a received digital token 600 can be compared to the expected counter value as indicated in the blockchain, and this comparison can be used to confirm that a digital token 600 is valid and not fraudulent or counterfeit.

The interaction identifier 604, which may be an alphanumeric value and can also be a global unique identifier (GUID), can identify a current transaction. Each time a digital token 600 is transferred, the transfer can be associated with a unique interaction identifier. The interaction identifier 604 can be updated or changed for each subsequent transaction.

The interaction identifier 604, counter value 603, and/or owner identifier 602 may all be updated at the same time for a new transaction, according to embodiments. Each time a digital token 600 data field is updated or changed, the changing entity (e.g., the current owner of the digital token 600) may provide a digital signature 607 (e.g., generated based on a private key and some or all data from the digital token 600) to certify the changes. The current digital signature 607 and/or one or more previous digital signatures can be included as a data field in the digital token 600.

The digital token 600 can represent a value being transferred or a promise of a value to be transferred. Accordingly, a token value 605 data field can be included in the digital token 600. In some embodiments, the token value 605 can take the form of currency. The token value 605 data field may represent a currency amount (e.g., 100, 1000, 10000, 100000, 1000000). Further, a currency denomination 606 data field (e.g., U.S. Dollars, CBDC-A, CBDC-B, etc.) can be included in the digital token 600. The token value 605 and/or currency denomination 606 may indicate a specific serial number, coin number, CBDC identifier, or other identifier for a specific value.

### Issue Digital Token

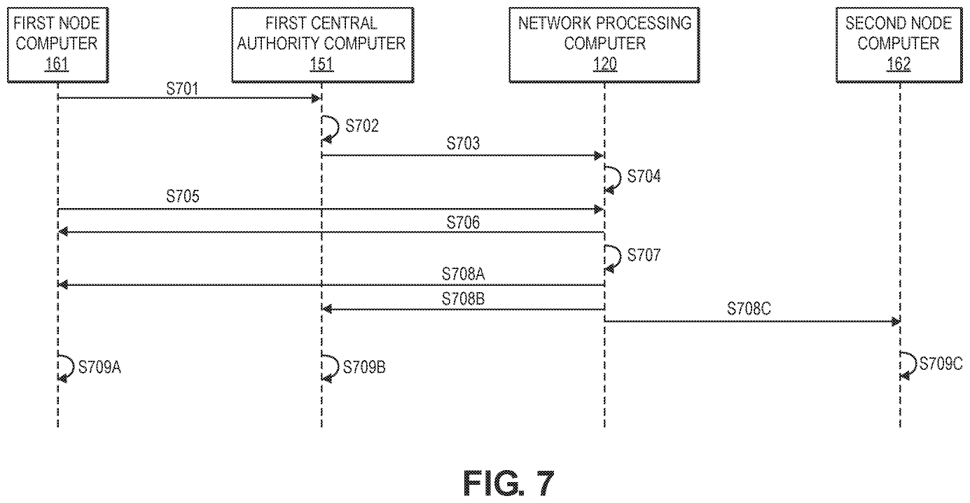

A method 700 for issuing a digital token according to embodiments of the invention can be described with respect to FIG. 7. Some elements in other Figures are also referred to. The steps shown in the method 700 may be performed sequentially or in any suitable order in embodiments of the invention. In some embodiments, one or more of the steps may be optional.

The various messages described below may use any suitable form of communication. In some embodiments, a request or response may be in an electronic message format, such as an e-mail, a short messaging service (SMS) message, a multimedia messaging service (MMS) message, a hypertext transfer protocol (HTTP) request message, a transmission control protocol (TCP) packet, a web form submission. The request or response may be directed to any suitable location, such as an e-mail address, a telephone number, an internet protocol (IP) address, or a uniform resource locator (URL). In some embodiments, a request or response may comprise a mix of different message types, such as both email and SMS messages.

A first user may wish to transfer a value to a second user for an interaction. The first user may have a first user account provided by a first entity (e.g., a first bank in a first country), and the second user may have a second user account provided by a second entity (e.g., a second bank in a second country). The first entity may operate a first node computer 161 that participates in a network, and the second entity may operate a second node computer 162 that participates in the network. The first node computer 161 can initiate a process for transferring the value via the network. First, the first node computer 161 can obtain a digital token that may subsequently be used to transfer the value to the second node computer 162.

At step S701, the first node computer 161 transfers a first value of a first exchange medium to the first central authority computer 151, which may be operated by a first central bank in a first country or region. For example, the first node computer 161 can send a message to the first central authority computer 151 requesting that the first value of a first fiat currency be exchanged for CBDC-A.

At step S702, the first central authority computer 151 can generate and/or issue a first amount of CBDC-A to the first node computer 161. For example, the first central authority computer 151 can reduce a first entity correspondent account at the first central bank by the first value of the first exchange medium (e.g., the first fiat currency), and the first central authority computer 151 can generate and/or assign a corresponding value of CBDC-A to the first node computer 161. The CBDC-A can include an indicator that the owner is the first node computer 161, an indication of the first amount, and any other suitable information. As a result, the first node computer 161 can have exchanged the first fiat currency for CBDC-A, which may be more easily transferred than the first fiat currency. In some embodiments, instead of using correspondent accounts, the first node computer 161 can electronically transfer the first value of the first exchange medium to the first central authority computer 151 via, for example, an Automated Clearing House (ACH) transfer.

In some embodiments, the CBDC-A generation and/or ownership can be recorded in a first local blockchain of a first local blockchain network (e.g., the first local blockchain network 111 in FIG. 1).

At step S703, the first central authority computer 151 can send a message to a network processing computer 120 informing the network processing computer about the transfer of the first value and/or the CBDC-A assigned to the first node computer 161.

At step S704, the network processing computer 120 updates a network ledger or record to indicate that the first amount of CBDC-A is assigned to the first node computer 161 (or the first entity). At this point, the value can be considered in escrow, as the first exchange medium (e.g., fiat currency) is no longer owned by the first node computer 161, and the CBDC-A is ready for transfer in real time.

In some embodiments, the blockchain may be mostly or solely utilized for digital token records. The network processing computer 120 may maintain a separate ledger or records for interactions and states of transfers in escrow. These separate records can be referred to as escrow accounts. In other embodiments, instead of maintaining separate records, the central blockchain may be updated with information about some or all transfer steps for an interaction.

The network processing computer 120 may manage, orchestrate, or follow an interaction from start to finish, and may check that each iterative step of a transfer is executed so that the interaction is carried to completion. The network processing computer 120 may track progress through updates to an escrow account. With the first value being held in escrow (e.g., in the form of issued CBDC-A), a token can now be issued that represents the first value.

At step S705, the first node computer 161 sends to the network processing computer 120 a request for a digital token that may subsequently be used to transfer the value to the second node computer. The token request can include information about the CBDC-A that is owned by the first node computer 161, which the requested digital token may represent.

At step S706, the network processing computer 120 issue and send a digital token to the first node computer 161. The digital token can comprise a token identifier, a token value, an owner identifier indicating that the first node computer 161 owns the digital token, a counter value, a first digital signature generated by the network processing computer 120, and/or any other suitable information. The token value may indicate the first amount of CBDC-A. In some embodiments, the token value may be less than the first amount of CBDC-A, for example, to account for transaction fees and/or exchange fees.

At step S707, the network processing computer 120 can update a blockchain ledger to include the digital token. For example, the network processing computer 120 generate a new block for the blockchain, the new block including a copy of the digital token or information about the digital token.

At steps S708A-C, the network processing computer 120 can broadcast information about the digital token and/or the updated blockchain to other nodes in the blockchain network, which can include the first node computer 161, the first central authority computer 151, the second node computer 162, and/or any other suitable entities. Accordingly, the network can be informed about the digital token owned by the first node computer 161, and that the digital token represents the first amount of CBDC-A.

At steps S709A-C, one or more of the first node computer 161, the first central authority computer 151, the second node computer 162, and/or any other suitable network participants can validate the new block received from the network processing computer 120 and update corresponding copies of the blockchain to include the new block.

### Transfer Digital Token

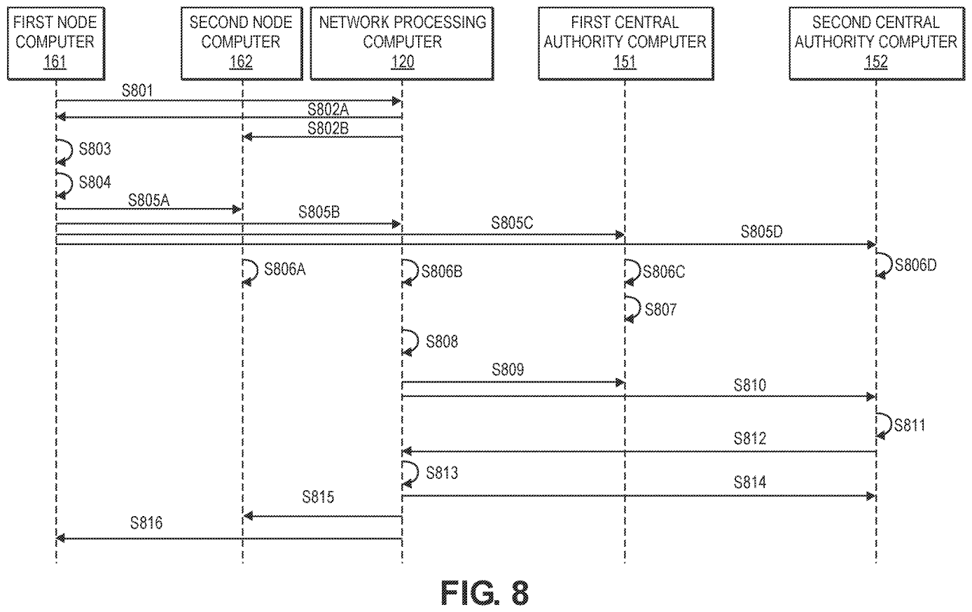

A method 800 of transferring a token according to embodiments of the invention can be described with respect to FIG. 8. Some elements in other Figures are also referred to. The steps shown in the method 800 may be performed sequentially or in any suitable order in embodiments of the invention. In some embodiments, one or more of the steps may be optional.

As explained above, a first user may wish to transfer a value to a second user for an interaction. The first user may have a first user account provided by a first entity (e.g., a first bank in a first country), and the second user may have a second user account provided by a second entity (e.g., a second bank in a second country). The first entity may operate a first node computer 161 that participates in a network, and the second entity may operate a second node computer 162 that participates in the network. The first node computer 161 can initiate a process for transferring the value via the network. First, the first node computer 161 can obtain a digital token that may subsequently be used to transfer the value to the second node computer 162.

Following the method 700 described above, the first node computer 161 can continue the interaction process by transferring the digital token.

At step S801, the first node computer 161 can request an interaction identifier from to the network processing computer 120. The request can include any suitable information about the intended transaction, such as the value being sent, the sender (e.g., the first user, first entity, and/or first node computer 161), the recipient (e.g., the second user, second entity, and/or second node computer 162), a token identifier, whether the transaction is a cross-network transaction and/or cross-border transaction, etc.

At step S802A, the network processing computer 120 generates and/or provides an interaction identifier to first node computer 161. Additionally, at step S802B, the network processing computer 120 can send the interaction identifier to the second node computer 162, thereby informing the second node computer 162 that the interaction has been initiated.

At step S803, the first node computer 161 can update the digital token in preparation for transferring the digital token to the second node computer 162 operated by the second entity. For example, the first node computer 161 can increase the counter value, change the owner identifier to indicate that the second node computer 162 now owns the digital token, add the interaction identifier to the digital token, and/or add a second digital signature generated by the first node computer 161.

At step S804, the first node computer 161 can record the updated digital token to a local copy of the blockchain. For example, the first node computer 161 can generate a new block for the blockchain, where the new block includes the digital token updates and/or a full copy of the digital token.

At steps S805A-D, the first node computer 161 can broadcast information about the updated digital token and/or the updated blockchain to other nodes in the blockchain network, which can include the network processing computer 120, the first central authority computer 151, the second node computer 162, the second central authority computer 152, and/or any other suitable network participants. Accordingly, the network can be informed about the changed ownership of the digital token.

At steps S806A-D, the other nodes in the blockchain network, which can include one or more of the network processing computer 120, the first central authority computer 151, the second node computer 162, the second central authority computer 152, and/or any other suitable network participants, can record the updated digital token to their respective blockchains. For example, each node can validate the new block received from the first node computer 161 and update a local copy of the blockchain to include the new block.

According to some embodiments, when the digital token ownership changes, this can trigger the transfer of a token value that may be indicated by the digital token but stored separated from the digital token. For example, when the token value is the first amount of CBDC-A, transfer of the digital token to another entity (e.g., to the second node computer 162) can trigger the transfer of the CBDC-A identified in the digital token to the same entity (e.g., to the second node computer 162) or to a suitable intermediary entity (e.g., the second central authority computer 152).

Accordingly, at step S807, in response to the broadcasted update about the digital token in step S805C, the first central authority computer 151 can change the ownership of the first amount of CBDC-A from the first node computer 161 to the second central authority computer 152. In some embodiments, the transfer of the CBDC-A can be recorded in the first local blockchain of the first local blockchain network.

The CBDC-A ownership may be changed to the second central authority computer 152 instead of the second node computer 162 because the second node computer 162 may be located in a second country and/or belong to a second local network. The second central authority computer 152 may administer the second local network, and may be able to provide a second exchange medium for the second network. Thus, the interaction value may first be transferred to the second central authority computer 152, which may subsequently be able to provide the interaction value to the second node computer 162 in a different desired form, as discussed further below.

At step S808, the network processing computer 120 updates the escrow account to indicate that the first amount of CBDC-A has been transferred from the first node computer 161 to the second central authority computer 152.

At step S809, the network processing computer 120 informs the first central authority computer 151 that the CBDC-A ownership transfer has been noted in the escrow account.

At step S810, the network processing computer 120 informs the second central authority computer 152 that it now owns the CBDC-A.

At step S811, after receiving ownership of the first amount of CBDC-A, the second central authority computer 152 can generate and/or assign a second amount of CBDC-B to the second node computer 162. The second amount of CBDC-B may have a value that is equivalent to or less than the value of the first amount of CBDC-A (e.g., due to transaction fees and/or exchange fees). The CBDC-B can include an indicator that the owner is the second node computer 162, an indication of the second amount, and any other suitable information.

In some embodiments, the CBDC-B generation and/or ownership can be recorded in a second local blockchain of a second local blockchain network (e.g., the second local blockchain network 112 in FIG. 1). The CBDC-B may be a second digital currency in a second country or region. Accordingly, generation of the CBDC-B can represent a cross-border transfer step.

At step S812, the second central authority computer 152 informs the network processing computer 120 that the second amount of CBDC-B has been assigned to the second node computer 162.

At step S813, the network processing computer 120 updates the escrow account to indicate that the second amount of CBDC-B has been assigned to the second node computer 162.

At step S814, the network processing computer 120 informs the second central authority computer 152 that the CBDC-B generating and assignment to the second node computer 162 has been noted in the escrow account.

At step S815, the network processing computer 120 informs the second node computer 162 that it owns the second amount of CBDC-B. Accordingly, even if the second entity has not yet received the value in the form of second fiat currency, the second node computer 162 may now at least own the interaction value in a local form.

At step S816, the network processing computer 120 informs the first node computer 161 that the second amount of CBDC-B has been assigned to the second node computer 162, which may effectively represent settlement or completion of the value transfer from the first node computer 161 to the second node computer 162.

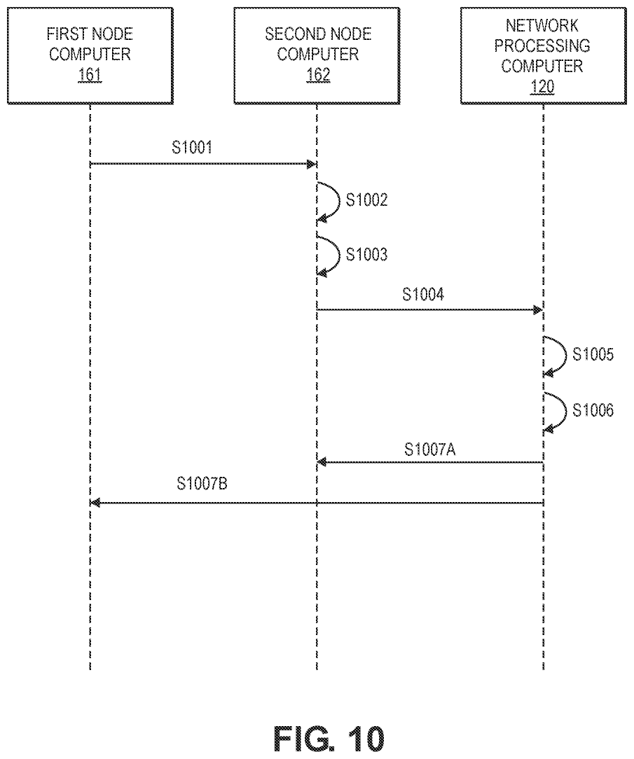

Accordingly, the second node computer 162 may have received the value transfer in the form of the digital token and/or the second amount of CBDC-B. The second node computer 162 may be able to utilize this value in one or more manners. For example, as discussed below with respect to FIG. 10, the second node computer 162 may redeem the digital token and/or the CBDC-B for fiat currency.

Alternatively, the second node computer 162 may keep the digital token and/or CBDC-B as a payment tool for a future interaction, as the digital token may be reusable. When desired, the second node computer 162 can provide the reusable digital token and/or CBDC-B to the third node computer 163 (or any other suitable node) during a second transaction between the second node computer 162 and the third node computer 163.

Some or all of the method 800 can be repeated for a subsequent interaction. For example, similar to step S801, the second node computer 162 can request a second interaction identifier. Similar to step S803, the second node computer 162 can further update the digital token by increasing the counter value, changing the owner identifier to indicate that the third node computer 163 now owns the digital token, adding the second interaction identifier and/or removing the previous interaction identifier, and/or adding another digital signature generated by the second node computer 162, thereby transferring the digital token to the third node computer 163. Similar to steps S804-S806, the further updated digital token can be recorded to the blockchain. Similar to step S807, the CBDC-B can be transferred away from the second node computer 162 to a third central authority computer, and similar to step S811, the third central authority computer can generate and/or assign a third amount of third type of CBDC (which may be referred to as CBDC-C) to the third node computer 163.

### Exchange Digital Token

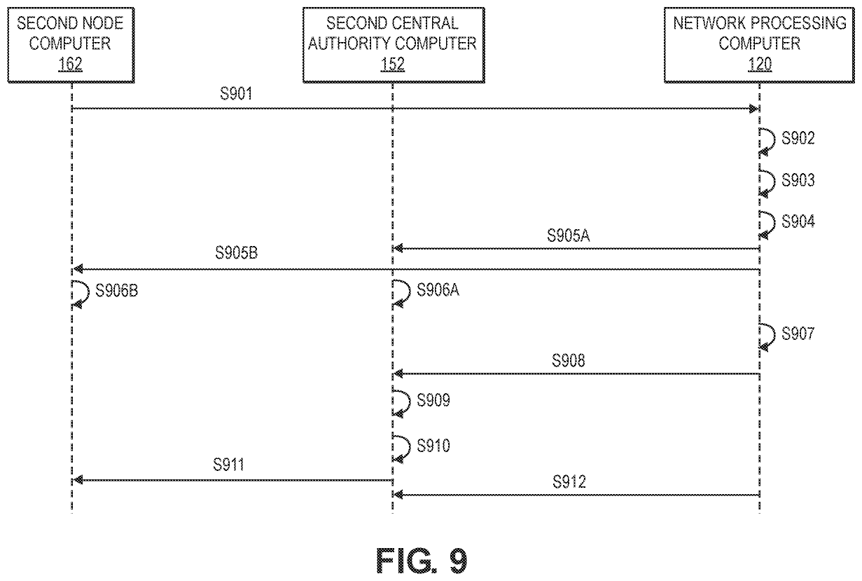

A method 900 for exchanging a digital token according to embodiments of the invention can be described with respect to FIG. 9. Some elements in other Figures are also referred to. The steps shown in the method 900 may be performed sequentially or in any suitable order in embodiments of the invention. In some embodiments, one or more of the steps may be optional.

Following the method 800 described above, the second node computer 162 can be the owner of the digital token and/or the second amount of CBDC-B. The second node computer 162 can then proceed exchange the digital token and/or the second amount of CBDC-B for a second value of a second exchange medium (e.g., a second fiat currency that is local to the second entity).

At step S901, the second node computer 162 can send a request to the network processing computer 120 to exchange the digital token for a second value of a second exchange medium. The exchange request can include a copy of the digital token.

At step S902, the network processing computer 120 can verify the authenticity of the digital token. For example, the network processing computer 120 can check whether a record of the digital token exists in the blockchain, and/or that the second node computer 162 is the owner of the digital token according to the blockchain (e.g., based on an owner identifier in the digital token such as a public key), and/or that the received digital token includes an expected counter value. The network processing computer 120 can be notified and/or the blockchain updated each time a counter value is incremented.

At step S903, the network processing computer 120 can update the digital token in preparation for exchanging the digital token. For example, the network processing computer 120 can change the owner identifier to indicate that the network processing computer 120 now owns the digital token, change the token value to zero, mark the digital token for destruction (e.g., by adding a flag or destruction indicator to the digital token), and/or add a third digital signature generated by the network processing computer 120.

At step S904, the network processing computer 120 can record the updated digital token to a local copy of the blockchain. For example, the network processing computer 120 can generate a new block for the blockchain, where the new block includes the digital token updates and/or a full copy of the digital token.

At steps S905A-B, the network processing computer 120 can broadcast information about the updated digital token and/or the updated blockchain to other nodes in the blockchain network, which can include one or more of the second node computer 162, the second central authority computer 152, the first node computer 161, the first central authority computer 151, and/or any other suitable network participants. Accordingly, the network can be informed about the changes to the digital token.

At steps S906A-B, the other nodes in the blockchain network, which can include one or more of the second node computer 162, the second central authority computer 152, the first node computer 161, the first central authority computer 151, and/or any other suitable network participants, can record the updated digital token to their respective blockchains. For example, each node can validate the new block received from the network processing computer 120 and update a local copy of the blockchain to include the new block.

At step S907, the network processing computer 120 can destroy the digital token. For example, the network processing computer 120 can update the blockchain to indicate that the digital token is no longer valid. This can include repeating steps S904-S906 to provide an additional update to the digital token to indicate that the digital token is no longer active, valid, or usable, and to further update the blockchain

At step S908, the network processing computer 120 informs the second central authority computer 152 that the digital token has been redeemed and/or destroyed. As a result, the second central authority computer 152 can be confident that no other parties will be able to exchange the digital token after the second node computer 162 exchanges the digital token.

At step S909, in response to the token redemption and/or destruction, the second central authority computer 152 can change the ownership of the second amount of CBDC-B from the second node computer 162 to the second central authority computer 152. Accordingly, the second central authority computer 152 can revoke the second amount of CBDC-B previously attributed to the second node computer 162 (e.g., during step S811 as discussed above with respect to FIG. 8), as the second node computer 162 is choosing to receive the token value in the form of the second exchange medium. In some embodiments, the CBDC-B transfer can be recorded in the second local blockchain of the second local blockchain network.

At step S910, the second central authority computer 152 can provide the second value in the second exchange medium (e.g., an amount of a second fiat currency) to the second node computer 162. For example, the second central authority computer 152, which may be operated by a second central bank in a second country or region, can increase a second entity correspondent account at the second central bank by the second value of the second exchange medium (e.g., the second fiat currency). In another example, the second central authority computer 152 can electronically transfer the second value of the second exchange medium from the second central bank to the second entity (e.g., via an Automated Clearing House transfer). In some embodiments, the second value in the second exchange medium may be equivalent to the first value in the first exchange medium. In other embodiments, the second value may be less than the first value due to one or more service fees, currency exchange fees, etc.

At step S911, the second central authority computer 152 informs the second node computer 162 that the second value of the second exchange medium has been provided to the second node computer 162 (e.g., via a second entity's correspondent account at the second central bank)

At step S912, the network processing computer 120 can record final details indicating that the transaction is complete. For example, the network processing computer 120 can record that the CBDC-B is now owned by the second central authority computer 152, that the second value of the second exchange medium has been provided to the second node computer 162, and/or that the escrow process is otherwise completed.

The steps discussed above with respect to FIGS. 7-9 are exemplary, and a number of alternatives are possible. For example, instead of utilizing CBDC to transfer the value between entities, correspondent bank accounts with fiat currencies can be utilized to transfer the value between each of the entities discussed above.

Additionally, in some embodiments, instead of exchanging the digital token and/or CBDC-B for the second exchange medium as discussed above with respect to FIG. 9, the second node computer 162 may keep the digital token and/or CBDC-B as a payment tool for a future transaction. When desired, the second node computer 162 can send the digital token and/or CBDC-B to a third node computer 163 (e.g., repeating some or all of the steps shown in FIG. 8) during a future transaction between the second node computer 162 and the third node computer 163. For example, second node computer 162 can further update the digital token again by further increasing the counter value and/or changing the owner to the third node computer 163, and the further updated digital token can be recorded to the blockchain in order to transfer the digital token to the third node computer 163.

Additionally, in some embodiments, two or more digital tokens can be provided together for a single transaction. For example, the second node computer 162 may simultaneously request and send one or more additional digital tokens (e.g., each having a respective token value) to the third node computer 163 along with the original digital token in order to provide a total value to the third node computer 163 that is greater than the value included in the original digital token.

Additionally, in some embodiments, a first portion of a digital token can be reused, while a second portion can be kept. For example, the second node computer 162 may be permitted to send a first portion (e.g., a fraction or percentage) of the token value to the third node computer 163, while retaining ownership of the remaining second portion of the token value.

### Failed Verification

A method 1000 according to embodiments of the invention can be described with respect to FIG. 10. Some elements in other Figures are also referred to. The steps shown in the method 1000 may be performed sequentially or in any suitable order in embodiments of the invention. In some embodiments, one or more of the steps may be optional.

Embodiments include various techniques for detecting and stopping counterfeit digital tokens. For example, as discussed above with respect to step S902 of FIG. 9, the network processing computer 120 may verify the authenticity of the digital token. If authenticity cannot be verified, the transaction may be canceled. The method 1000 provides various steps for managing digital tokens that cannot be verified as authentic.

At step S1001, the first node computer 161 may provide a digital token to another node for verification, such as the second node computer 162 (or the network processing computer 120). For example, step S1001 may be similar to step S901 where the second node computer 162 sends a request to the network processing computer 120 to exchange a digital token.

At step S1002, a network node, such as the second node computer 162, may attempt to verify the authenticity of the digital token. For example, step S1002 may be similar to step S902 where the network processing computer 120 checks whether a record of the digital token exists in the blockchain, and/or that one or more details in the received digital token match details indicated in the blockchain (e.g., matching counter value, matching owner, etc.)

At step S1003, the network node, such as the second node computer 162, can determine that verification is failed and the token is not authentic (e.g., counterfeit, out-of-date, previously destroyed, etc.). For example, the counter value in the received digital token may be out-of-sequence or otherwise incorrect, or the digital signature may not be verifiable. The network node may determine not to perform any requested tasks (e.g., entering digital token updates into the blockchain), and may proceed to alert one or more other network nodes about the failed verification.

At step S1004, the network node, such as the second node computer 162, can send a report to the network processing computer 120 about the failed verification. The report message can include information about the digital token and/or reasons why verification failed (e.g., incorrect counter value in the provided digital token).

At step S1005, the network processing computer 120 can attempt to verify the digital token again. For example, the network processing computer 120 can repeat steps S1002-S1003, and thereby confirm that the digital token is invalid.

At step S1006, the network processing computer 120 can take one or more actions based on the failed verification. For example, the network processing computer 120 can suspend activities for the network node that submitted the invalid digital token (e.g., the first node computer 161). Activities may be suspended for a predetermined amount of time (e.g., an hour, a day, or a week), or until the issue is resolved.

At steps S1007A-B, the network processing computer 120 broadcast information about the failed verification and/or responsive actions taken (e.g., suspension of activity for the offending node and duration of suspension). Additionally, the network processing computer 120 may also inform network nodes that any attempted blockchain update with the invalid token should not be recorded.

Embodiments of the invention have a number of advantages. For example, in embodiments of the invention, multiple local networks can interact with one another through the central network. As a result, separate local networks can maintain privacy and customizable local rules and procedures, and at the same time a global-level of real time connectivity is established.

Additionally, embodiments provide digital tokens that can serve as an intermediary value between local exchange mediums, thereby enabling value transfers across networks and types of exchange mediums. Even if local networks utilize different exchange mediums, each local exchange medium can be represented by or interchanged for a digital token in the central network. For example, when a value is being transferred from a first local network to a second local network, a value provided in the form of a first exchange medium of the first local network can be interchanged for a digital token. Then, the digital token can be redeemed for a second local exchange medium of the second local network.

Additionally, embodiments provide digital tokens that can be monitored and verifiable based on a counter value and/or recorded previous usage of the digital token, thereby providing a secure mechanism for cross-network value transfers. Digital tokens may be transferred multiple times to multiple different owners, and the counter value can be increased at each transfer and/or change of ownership.

Further, a digital token can be redeemed the token value for a local exchange medium. At that time, the digital token can be destroyed and removed from circulation. As a result, the central network provides a secure, temporary, redeemable, and disposable medium for cross-network exchange.

A computer system will now be described that may be used to implement any of the entities or components described herein. Subsystems in the computer system are interconnected via a system bus. Additional subsystems include a printer, a keyboard, a fixed disk, and a monitor which can be coupled to a display adapter. Peripherals and input/output (I/O) devices, which can couple to an I/O controller, can be connected to the computer system by any number of means known in the art, such as a serial port. For example, a serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method comprising:
transferring, by a first node computer operated by a first entity, a first value of an exchange medium to a first central authority computer, which sends a message to a network processing computer informing the network processing computer about the transfer of the first value;
receiving, by the first node computer, from the network processing computer, a digital token comprising a digital token identifier, an owner identifier identifying the first entity, a counter value, a token value, a first digital signature;
updating, by the first node computer, the digital token to transfer the digital token to a second node computer operated by a second entity by increasing the counter value, changing the owner identifier to identify the second entity, and adding a second digital signature of the first node computer; and
broadcasting, by the first node computer, the updated digital token to nodes in a blockchain network, the blockchain network comprising the first node computer, the second node computer, the first central authority computer, and the network processing computer, wherein the nodes record the updated digital token to their respective blockchains.

2. The method of claim 1, wherein the token value is based on the first value.

3. The method of claim 2, wherein the token value is less than the first value.

4. The method of claim 1, further comprising:
recording, by the first node computer, the updated digital token to a blockchain copy at the first node computer.

5. The method of claim 1, wherein the first central authority computer transfers the first value of the exchange medium to a second central authority computer.

6. The method of claim 1, wherein the exchange medium is a first exchange medium, and a second central authority computer transfers a second value of a second exchange medium to the second node computer operated by the second entity.

7. The method of claim 6, wherein the blockchain network is a central blockchain network, the first exchange medium is associated with a first local blockchain network, and the second exchange medium is associated with a second local blockchain network.

8. The method of claim 6, wherein the second node computer provides the digital token in exchange for the second value of the second exchange medium.

9. The method of claim 8, wherein the network processing computer destroys the digital token.

10. The method of claim 1, wherein the second node computer further updates the digital token to transfer the digital token to a third node computer operated by a third entity by increasing the counter value, changing the owner identifier to identify the third entity, and adding a third digital signature of the second node computer.

11. The method of claim 10, wherein the second node computer broadcasts the further updated digital token to the nodes in the blockchain network, and where the nodes record the further updated digital token to their respective blockchains.

12. The method of claim 1, wherein the nodes in the blockchain network validate the updated digital token before recording the updated digital token to their respective blockchains.

13. The method of claim 1, wherein validating includes determining that the counter value in the updated digital token is correct based on records in a blockchain.

14. The method of claim 1, wherein the digital token is a first digital token, and further comprising:
receiving, by the first node computer, from the network processing computer, a plurality of digital tokens including the first digital token, where each of the plurality of digital tokens comprises a respective token value, the plurality of digital tokens taken together represent a total value, the total value being based on the first value.

15. A first node computer comprising:
a processor; and
a computer readable medium, the computer readable medium comprising code, executable by the processor, for implementing a method comprising:
transferring a first value of an exchange medium to a first central authority computer, which sends a message to a network processing computer informing the network processing computer about the transfer of the first value;
receiving, from the network processing computer, a digital token comprising a digital token identifier, an owner identifier identifying a first entity, a counter value, a token value, a first digital signature;
updating the digital token to transfer the digital token to a second node computer operated by a second entity by increasing the counter value, changing the owner identifier to identify the second entity, and adding a second digital signature of the first node computer; and
broadcasting the updated digital token to nodes in a blockchain network, the blockchain network comprising the first node computer, the second node computer, the first central authority computer, and the network processing computer, wherein the nodes record the updated digital token to their respective blockchains.

16. A method comprising:
receiving, by a network processing computer, a message regarding a transfer by a first node computer operated by a first entity of a first value of an exchange medium to a first central authority computer;
providing, by the network processing computer to the first node computer, a digital token comprising a digital token identifier, an owner identifier identifying the first entity, a counter value, a token value, a first digital signature, wherein the first node computer updates the digital token to transfer the digital token to a second node computer operated by a second entity by increasing the counter value, changing the owner identifier to identify the second entity, and adding a second digital signature of the first node computer;
receiving, by the network processing computer, a broadcast message comprising the updated digital token; and
updating, by the network processing computer, a blockchain stored in the network processing computer with the updated digital token,
wherein the network processing computer is in blockchain network comprising the first node computer, the second node computer, the first central authority computer, and the network processing computer.

17. The method of claim 16, wherein the message is received from the first central authority computer, and further comprising:
generating, by the network processing computer, the digital token including using a first private key to generate the first digital signature, where the first node computer uses a second private key to generate the second digital signature.

18. The method of claim 16, further comprising:
receiving, by the network processing computer, from the second node computer, the digital token in exchange for a second value of a second exchange medium; and
destroying, by the network processing computer, the digital token.

19. The method of claim 16, further comprising:
validating the updated digital token, wherein validating includes determining that the counter value is correct based on records in the blockchain.

20. The method of claim 16, wherein the token value is based on the first value.
